(19) United States
(12) Patent Application Publication
(10) Pub. No.: US 2024/0377580 A1
(43) Pub. Date: Nov. 14, 2024

(54) OPTICAL DEVICE AND METHODS OF MANUFACTURE

(71) Applicant: Taiwan Semiconductor Manufacturing Co., Ltd., Hsinchu (TW)

(72) Inventors: Chia-Ning Weng, Taichung City (TW); Chia-Chen Chou, Hsinchu (TW); Shih Wei Liang, Taichung City (TW)

(21) Appl. No.: 18/526,786

(22) Filed: Dec. 1, 2023

Related U.S. Application Data
(60) Provisional application No. 63/509,797, filed on Jun. 23, 2023.
(60) Provisional application No. 63/501,464, filed on May 11, 2023.

(51) Int. Cl. G02B 6/122; G02B 6/12

(52) U.S. Cl. CPC G02B 6/122; G02B 6/12004

(57) ABSTRACT

Optical devices and methods of manufacture with individually tailored lens are presented. In some embodiments the optical device comprises a first substrate, a first lens on a first side of the first substrate, the first lens having a first radius of curvature, and a second lens on the first side of the first substrate, the second lens having a second radius of curvature different from the first radius of curvature.

### PRIORITY CLAIM AND CROSS-REFERENCE

This application claims the benefit of U.S. Provisional Application No. 63/501,464, filed on May 11, 2023, and U.S. Provisional Application No. 63/509,797, filed on Jun. 23, 2023, which applications are hereby incorporated herein by reference.

### BACKGROUND

Electrical signaling and processing are one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Packages thus may include both optical (photonic) dies including optical devices and electronic dies including electronic devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a first substrate with a first lens and a second lens, in accordance with some embodiments.

FIG. 2 illustrates formation of a first active layer of first optical components, in accordance with some embodiments.

FIG. 3 illustrates formation of a first mirror and a second mirror, in accordance with some embodiments.

FIG. 4 illustrates transmission of an optical signal through the first lens and the second lens, in accordance with some embodiments.

FIG. 5 illustrates a bonding of a first die and a second die, in accordance with some embodiments.

FIG. 6 illustrates transmission of an optical signal through the first die, the second die, and the optical interposer, in accordance with some embodiments.

FIG. 7 illustrates formation of a fifth lens and a sixth lens, in accordance with some embodiments.

FIG. 8 illustrates formation of the first lens, the second lens, the third lens, the fourth lens, the fifth lens, and the sixth lens on the first substrate, in accordance with some embodiments.

FIG. 9 illustrates formation of the first lens, the second lens, the fifth lens, and the sixth lens on the first substrate, in accordance with some embodiments.

FIG. 10 illustrates the use of optical fibers with the optical interposer, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be described with respect to a particular embodiment in which lens utilized with an optical interconnect 100 are formed using different dimensions in order to reduce optical losses associated with receiving and transmission to and from the optical interconnect 100. However, the ideas presented herein may be utilized in a wide variety of embodiments, and the embodiments presented are not intended to be limited to the precise embodiments described.

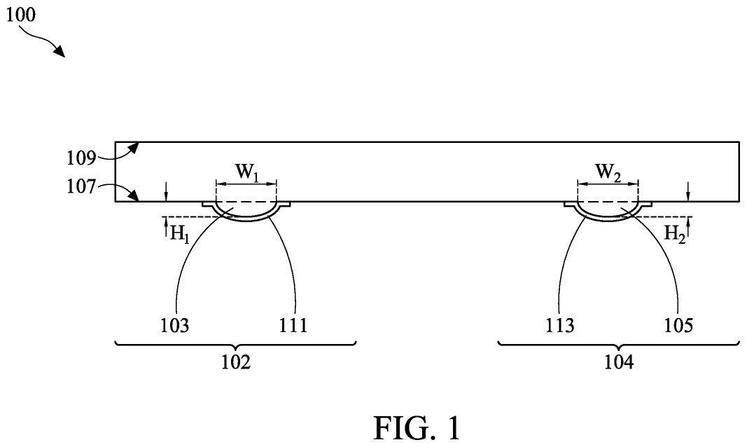

With reference now to FIG. 1, there is illustrated a first substrate 101 with a first lens 103 within a receiving region 102 and a second lens 105 within a transmission region 104 that will be used as part of the optical interconnect 100. In an embodiment the first substrate 101 may be a semiconductor material such as silicon or germanium, a dielectric material such as glass, or any other suitable material that allows for structural support of overlying devices along with the formation of the first lens 103 and the second lens 105. However, any suitable material may be utilized.

The first lens 103 is located along a first side 107 of the first substrate 101 opposite a second side 109 of the first substrate 101. In an embodiment the first lens 103 may be formed from the material of the first substrate 101 using, e.g., a first photolithographic masking and etching process. For example, in a particular embodiment the first lens 103 may be formed by initially placing and patterning a photoresist (e.g., a single layer or multiple layer photoresist) and then using the patterned photoresist as a mask to etch the material of the first substrate 101 to form the first lens 103 protruding from the first surface 107 with the desired shape.

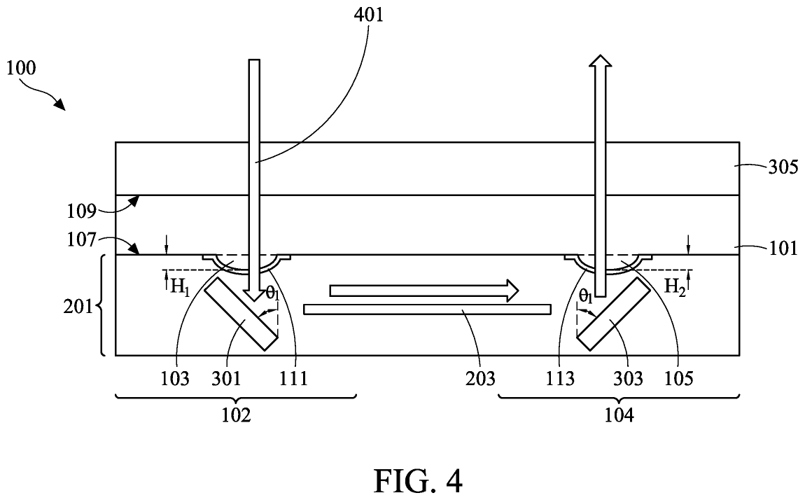

In an embodiment the first lens 103 is shaped in order to minimize optical losses from receiving an optical signal 401 (described further below with respect to FIG. 4). For example, in a particular embodiment the first lens 103 may have a first height H1 of between about 2 μm and about 13 μm and a first width W1 of between about 20 μm and about 120 μm. As such, the first lens 103 may have a radius of curvature of between about 30 μm and about 700 μm. However, any suitable dimensions may be utilized.

The second lens 105 is also located along the first side 107 of the first substrate 101 and may be formed from the material of the first substrate 101 using, e.g., a second photolithographic masking and etching process. For example, in a particular embodiment the second lens 105 may be formed by initially placing and patterning a photoresist (e.g., a single layer or multiple layer photoresist) and then using the patterned photoresist as a mask to etch the material of the first substrate 101 to form the second lens 105 with the desired shape.

In an embodiment the second lens 105 is shaped in order to minimize optical losses from transmitting (not receiving) an optical signal 401 (described further below with respect to FIG. 4). As such, the second lens 105 has different dimensions than the first lens 103. For example, in a particular embodiment the second lens 105 may have a second height H₂ of between about 3 μm and about 15 μm and a second width W₂ of between about 20 μm and about 100 μm. Further, the second lens 105 may have a radius of curvature that is different from the first lens 103, such as having a radius of curvature of between about 65 μm and about 800 μm. However, any suitable dimensions may be utilized.

In particular examples in which the first lens 103 has a different dimension from the second lens 105, when the first height H₁ is the same as the second height H₂, then the first width W₁ is not equal to the second width W₂. In other embodiments the first height H₁ may be different from the second height H₂, the first width W₁ may be equal to the second width W₂. In yet other embodiments, the first height H₁ may not be equal to the second height H₂ while the first width W₁ is not equal to the second width W₂.

Of course, while the formation of the second lens 105 is described above as being manufactured using separate masking and etching processes from the first lens 103, this is intended to be illustrative and is not intended to limit the presented embodiments. Rather, is some embodiments, such as when a difference between the first height H₁ and the second height H₂ is between 0 μm and 1 μm, the first lens 103 and the second lens 105 may be manufactured using a single patterning process. If the difference is larger than 1 μm, two or more patterning processes may be utilized. Any suitable combination of processes may be utilized.

FIG. 1 additionally illustrates formation of a first anti-reflective coating (ARC) 111 and a second ARC 113 over the first lens 103 and the second lens 105, respectively. In an embodiment the first ARC 111 and the second ARC 113 may be one or more layers of materials which help to prevent undesired reflections as light is focused through the first lens 103 and the second lens 105. In a particular embodiment the one or more layers of materials may be materials such as silicon oxide, silicon nitride, combinations of these, or the like, formed using processes such as chemical vapor deposition, atomic layer deposition, physical vapor deposition, oxidation, nitridation, combinations of these, or the like.

In a particular embodiment the first ARC 111 and the second ARC 113 may be formed using a first layer of silicon oxide and a first layer of silicon nitride formed over the first layer of silicon oxide. A second layer of silicon oxide and a second layer of silicon nitride are deposited over the first layer of silicon oxide and the first layer of silicon nitride, forming an alternating stack of silicon oxide and silicon nitride. Once all of the desired layers have been deposited, the layers may be patterned using, e.g., a photolithographic masking and etching process. However, any suitable combinations of materials and processes may be utilized.

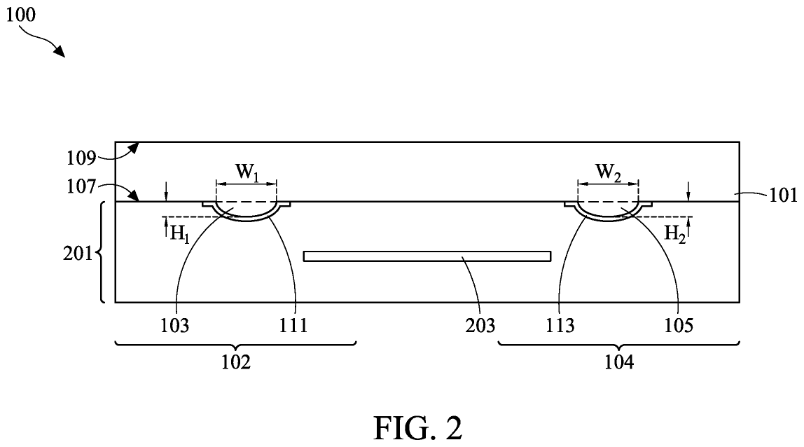

FIG. 2 illustrates formation of a first active layer 201 of first optical components 203 (represented in FIG. 2 by a single waveguide) adjacent to the first lens 103 and the second lens 105. In an embodiment the first active layer 201 is formed of alternating layers of core material and cladding material and may be formed through any suitable processes to form one or more first optical components 203. In some embodiments the cladding material may be a dielectric material with an n of about 1.5, such as silicon oxide deposited through a deposition process such as chemical vapor deposition, physical vapor deposition, atomic layer deposition, combinations of these, or the like. However, any suitable material and method of deposition may be utilized.

In some embodiments the first optical components 203 of the first active layer 201 may include active and passive components such as couplers (e.g., edge couplers, grating couplers, etc.) for connection to outside signals, optical waveguides (e.g., ridge waveguides, rib waveguides, buried channel waveguides, diffused waveguides, etc.), optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more first optical components 203.

In an embodiment the one or more first optical components 203 may be formed by initially depositing a material for the one or more first optical components 203. In an embodiment the material for the one or more first optical components 203 may be a material such as silicon nitride, silicon, lithium niobate (LNO), barium titanate (BTO), silicon oxide, a waveguide polymer materials (e.g., SU8), combinations of these, or the like, deposited using a deposition method such as chemical vapor deposition, atomic layer deposition, physical vapor deposition, combinations of these, or the like. However, any suitable material and any suitable method of deposition may be utilized.

Once the material for the one or more first optical components 203 has been deposited or otherwise formed, the material may be patterned into the desired shapes for the one or more first optical components 203. In an embodiment the material of the one or more first optical components 203 may be patterned using, e.g., one or more photolithographic masking and etching processes. However, any suitable method of patterning the material for the one or more first optical components 203 may be utilized.

For some of the one or more first optical components 203, such as waveguides or edge couplers, the patterning process may be all or at least most manufacturing that is used to form these components. Additionally, for those components that utilize further manufacturing processes, such as Mach-Zehnder silicon-photonic switches that utilize resistive heating elements, additional processing may be performed either before or after the patterning of the material for the one or more first optical components 203. For example, implantation processes, additional deposition and patterning processes for different materials, combinations of all of these processes, or the like, and can be utilized to help further the manufacturing of the various desired one or more first optical components 203. All such manufacturing processes and all suitable first optical components 203 may be manufactured, and all such combinations are fully intended to be included within the scope of the embodiments.

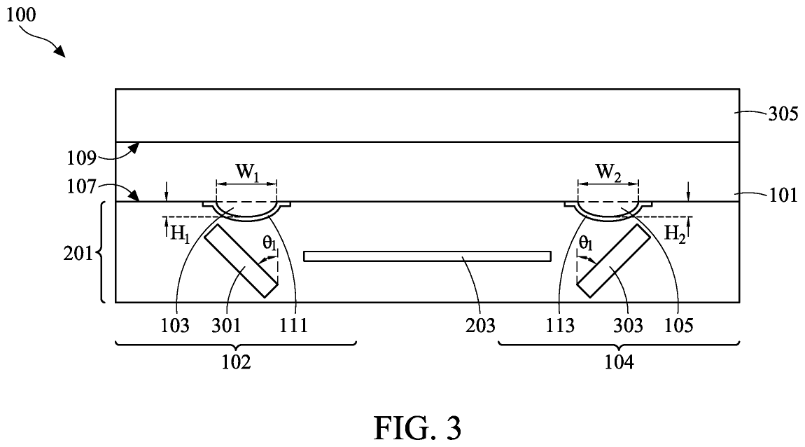

FIG. 3 illustrates formation of a first mirror 301 and a second mirror 303 within the first active layer 201 of first optical components 203 in order to direct light between the first optical components 203 and the first lens 103 and the second lens 105. In an embodiment, the first mirror 301 and the second mirror 303 may be formed by initially patterning one or more layers of the first active layer 201 using a photolithographic masking and etching process. For example, in a particular embodiment the one or more layers of the first active layer 201 may be patterned by initially depositing a photoresist layer (not separately illustrated in FIG. 3) and then imaging the photoresist layer using, e.g., a mask with different transparency regions (e.g., partially transparent regions, fully transparent region) that determine an amount of the imaging radiation that passes through.

Because of the different transparency regions, during the imaging process a radiating source directs radiation through the different transparency regions to form a patterned energy source which then strikes the photoresist layer. In accordance with some embodiments, a geometry of the pattern caused by the different transparency regions is formed, and by controlling the amount of energy the various portions of the photoresist layer exposed to the patterned energy source can be further controlled and/or varied across the depth of the first photoresist layer to form the desired pattern for the first mirror 301 and the second mirror 303. The penetration depth of the patterned energy source into the first photoresist layer during the first patterning process may form the pattern to have sloped sidewalls corresponding to the penetration depth of the patterned energy source.

Once the photoresist layer has been imaged, the photoresist layer may be developed. The developer physically removes the pattern of the photoresist layer exposed to the patterned energy source forming openings for the first mirror 301 and the second mirror 303.

Once the photoresist layer has been imaged and developed, the photoresist layer may be used as a mask in an etching process to transfer the image within the photoresist layer to the underlying layers of the first active layer 201 of first optical components 203. The etching process may be one or more etching processes, such as a dry etch process, a wet etch process, a reactive ion etching process, the like, or a combination thereof. In an embodiment, following the etching step, the openings within the first active layer 201 of first optical components 203 have a first angle θ1 between sloped sidewalls of the openings and a plane perpendicular with a major surface of the first substrate 101 of between about 40° and about 50°, such as 45°. However, any suitable etching process utilizing any suitable etchants and etching parameters may be used.

In accordance with some embodiments, following the formation of the openings, any remaining portion of the photoresist layer that is still present may be removed. The photoresist layer may be removed using an ashing process, whereby a temperature of the photoresist layer is raised to induce a thermal decomposition, which may then be easily removed. However, any suitable method may be used in order to remove the photoresist layer.

Once the openings within the first active layer 201 have been formed, the openings may be lined with a mirror coating (not separately illustrated from the first mirror 301 and the second mirror 303 in FIG. 3). In an embodiment the mirror coating may be a single layer of a reflective material such as copper, gold, aluminum, combinations of these, or the like, or else may be a multi-layer structure such as a Bragg's reflector comprising alternating layers of silicon dioxide and amorphous silicon. The individual materials of the mirror coating may be deposited using any suitable methods, such as chemical vapor deposition, physical vapor deposition, plating, combinations of these, or the like, and the individual layers may be then be further patterned using, e.g., a photolithographic masking and etching process (for example, to remove horizontal portions of the deposited materials).

Once the materials for the mirror coating have been deposited, further cladding material may be deposited in order to fill the openings formed for the first mirror 301 and the second mirror 303. In an embodiment the further cladding material may be the same cladding material as the surrounding layers of the first active layer 201 of the first optical components 203. However, any suitable materials may be utilized.

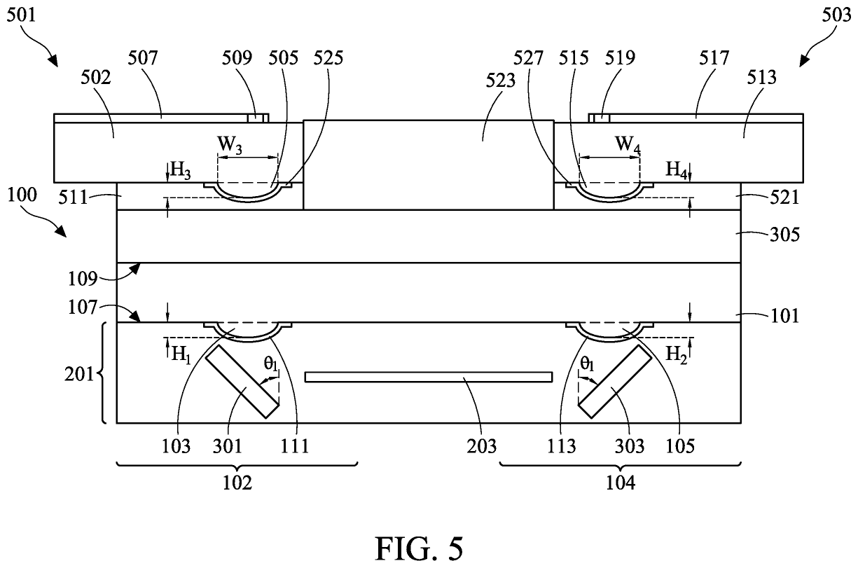

FIG. 3 additionally illustrates formation of a first bonding layer 305 adjacent to the second side 109 of the first substrate 101. In an embodiment, the first bonding layer 305 may be used as part of a dielectric-to-dielectric bond to subsequently attached structures (not illustrated in FIG. 3 but illustrated and described further below with respect to FIG. 5). In accordance with some embodiments, the first bonding layer 305 is formed of a dielectric material such as silicon oxide, silicon nitride, or the like. The dielectric material may be deposited using any suitable method, such as CVD, high-density plasma chemical vapor deposition (HDPCVD), PVD, ALD, or the like. However, any suitable materials and deposition processes may be utilized.

FIG. 4 illustrates the optical signal 401 (represented in FIG. 4 by the arrows) traversing through the optical interconnect 100. As can be seen in FIG. 4, the optical interconnect 100 receives the optical signal 401 through the first lens 103 so that the optical signal 401 is reflected by the first mirror 301 into the first optical components 203 (e.g., into an edge coupler within the first optical components 203). The first optical components 203 route the optical signal 401 and perform any desired modulation of the optical signal 401 until the optical signal 401 is eventually transmitted to the second mirror 303, which reflects the optical signal 401 through the second lens 105 and, eventually, out of the optical interconnect 100.

However, because the first lens 103 is specifically designed to minimize optical loss for receiving the optical signal 401 and because the second lens 105 is specifically designed to minimize optical loss for transmitting the optical signal 401, the overall optical loss as the optical signal 401 is traversing through the optical interconnect 100 can be minimized. Additionally, by minimizing the optical losses due to transmission, an overall more efficient device can be obtained.

FIG. 5 illustrates an embodiment in which the optical interconnect 100 is receiving and transmitting the optical signal 401 from a first die 501 and a second die 503. In an embodiment the first die 501 and the second die 503 are separated dies that are manufactured separately from each other. However, in other embodiments the first die 501 and the second die 503 may be part of a single device or be attached to each other prior to connection with the optical interconnect 100. Any suitable devices may be utilized.

In an embodiment the first die 501 may comprise a support substrate 502 with a third lens 505, a first optical device signal component 507, and a third mirror 509. In an embodiment the support substrate 502 may be similar to the first substrate 101, such as by being a material such as silicon or glass. However, any suitable material may be utilized.

The third lens 505 may be formed along a side of the first die 501 that will face the optical interconnect 100. In an embodiment the third lens 505 may be formed from material of the support substrate 502 using similar processes as the first lens 103 described above with respect to FIG. 1. However, any suitable processes may be utilized.

In an embodiment the third lens 505 is shaped in order to minimize optical losses from transmitting the optical signal 401 to the optical signal 401. For example, in a particular embodiment the third lens 505 may have a third height H₃ of between about 2 μm and about 15 μm and a third width W₃ of between about 60 μm and about 120 μm. As such, the third lens 505 may have a radius of curvature of between about 130 μm and about 290 μm. However, any suitable dimensions may be utilized.

The first optical device signal component 507 may comprise one or more optical fibers (not separately illustrated in FIG. 5) as part of a fiber array unit (FAU). In an embodiment each of the one or more optical fibers may comprise a core material such as glass surrounded by one or more cladding materials. Optionally, a surrounding cover material may be used to surround the outer cladding material in order to provide additional protection.

Further in the embodiment in which the first optical device signal component 507 comprises a fiber array unit, the first optical device signal component 507 may be a ferrule (not separately illustrated) that is attached to a fiber bundle of optical fibers. In an embodiment, the ferrule may be used to receive the plurality of optical fibers, align the optical fibers, and connect the optical fibers to the support substrate 502. In an embodiment, the ferrule may be a mechanical transfer (MT) ferrule and the like made of a material that can be used to protect, support and align the individual optical fibers. However, any suitable materials may be utilized. In an embodiment, the optical fibers may be inserted into openings located within the ferrule. Once inserted a glue material, such as an epoxy, silicone, a photocurable elastic polymer, combinations of these, or the like, may be injected or otherwise placed into the openings within the ferrule in order to secure the optical fibers within the ferrule. Additionally, a curing process such as a light cure, a heat cure, or the like, may be utilized to harden the glue material, and the optical fibers may be polished and cleaned in order to prepare the optical fibers within the ferrule for optical connection to the optical interconnect 100. In this embodiment, the ferrule helps secure the optical fibers to the support substrate 502 such that the optical signal 401 provided by the optical fibers may be transmitted to the optical interconnect 100.

The third mirror 509 may be utilized to reflect the optical signal 401 from the first optical device signal component 507 to the third lens 505, such as by reflecting the optical signal 401 at a 45° angle from the first optical device signal component 507 towards the third lens 505. In some embodiments the third mirror 509 may be external to the first optical device signal component 507. In other embodiments the third mirror 509 may be formed within the first optical device signal component 507 using similar processes and materials as the first mirror 301 (described above with respect to FIG. 3). Any suitable arrangement may be utilized.

FIG. 5 additionally illustrates formation of a third ARC 525 adjacent to the third lens 505. In an embodiment the third ARC 525 is formed using similar materials and methods as the first ARC 111 and the second ARC 113, such as depositing one or more materials and then patterning the deposited material. However, any suitable materials and methods may be utilized.

FIG. 5 additionally illustrates an attachment of the first die 501 to the optical interconnect 100. In an embodiment the attachment may be initiated by depositing a second bonding layer 511 over the third lens 505. In an embodiment the second bonding layer 511 may be formed using similar materials and similar processes as the first bonding layer 305 (described above with respect to FIG. 3), such as by being a material such as silicon dioxide. However, any suitable materials and processes may be utilized.

Once the second bonding layer 511 has been prepared, the first die 501 may be bonded to the optical interconnect 100 using a fusion bonding process. In an embodiment a surface of the first bonding layer 305 and the second bonding layer 511 may first be activated utilizing, e.g., a dry treatment, a wet treatment, a plasma treatment, exposure to an inert gas, exposure to H₂, exposure to N₂, exposure to O₂, or combinations thereof, as examples. In embodiments where a wet treatment is used, an RCA cleaning may be used, for example. However, any suitable activation process may be utilized.

After the activation process the first bonding layer 305 and the second bonding layer 511 may be cleaned using, e.g., a chemical rinse, and then the first bonding layer 305 is aligned and placed into physical contact with the second bonding layer 511. The first bonding layer 305 and the second bonding layer 511 are then subjected to thermal treatment and contact pressure to bond the first die 501 to the optical interconnect 100. In this manner, bonding of the optical interconnect 100 and the first die 501 forms a bonded device. In some embodiments, the bonded devices may be baked, annealed, pressed, or otherwise treated to strengthen or finalize the bond.

Additionally, while the above description describes a fusion bonding process, this is intended to be illustrative and is not intended to be limiting. In yet other embodiments, the first bonding layer 305 and the second bonding layer 511 may be bonded by dielectric-to-dielectric and metal-to-metal bonding or another bonding process. Any suitable bonding process may be utilized, and all such methods are fully intended to be included within the scope of the embodiments.

The second die 503 comprises a second support substrate 513 with a fourth lens 515, a second optical device signal component 517, a fourth mirror 519, a fourth ARC 527, and a third bonding layer 521. In an embodiment the second support substrate 513, the fourth lens 515, the second optical device signal component 517, the fourth mirror 519, the fourth ARC 527, and the third bonding layer 521 may be similar to the support substrate 502, the third lens 505, the first optical device signal component 507, the third mirror 509, the third ARC 525, and the second bonding layer 511 as described above. However, any suitable materials and processes may be utilized.

In an embodiment, however, the fourth lens 515 is shaped in order to minimize optical losses from receiving the optical signal 401 being transmitted from the optical interconnect 100. For example, in a particular embodiment the fourth lens 515 may have a fourth height H₄ of between about 2 μm and about 12 μm and a fourth width W₄ of between about 50 μm and about 120 μm. As such, the fourth lens 515 may have a radius of curvature that is different from the radius of curvature of the third lens 505, such as having a radius of curvature of between about 155 μm and about 900 μm. However, any suitable dimensions may be utilized.

In particular examples in which the third lens 505 has a different dimension from the fourth lens 515, when the third height H₃ is the same as the fourth height H₄, then the third width W₃ is not equal to the fourth width W₄. In other embodiments the third height H₃ may be different from the fourth height H₄, the third width W₃ may be equal to the fourth width W₄. In yet other embodiments, the third height H₃ may not be equal to the fourth height H₄ while the third width W₃ is not equal to the fourth width W₄.

Additionally, while the described embodiments describe the first lens 103 having different dimensions from the second lens 105 at the same time that the third lens 505 has different dimensions from the fourth lens 515, this is intended to be illustrative and is not intended to be limiting. Rather, the first lens 103 may have different dimensions from the second lens 105 while the dimensions of the third lens 505 and the fourth lens 515 have the same dimensions, or the third lens 505 and the fourth lens 515 may have different dimensions while the first lens 103 and the second lens 105 have the same dimensions. Any suitable combinations may be utilized, and all such combinations are fully intended to be included within the scope of the embodiments.

Of course, while the formation of the third lens 505 is described above as being manufactured using separate masking and etching processes from the fourth lens 515 (for embodiments in which the first die 501 is manufactured separately from the second die 503), this is intended to be illustrative and is not intended to limit the presented embodiments. Rather, is some embodiments, such as when the first die 501 and the second die 503 are part of a single device or already connected together, when a difference between the third height H₃ and the fourth height H₄ is between 0 μm and 1 μm, the third lens 505 and the fourth lens 515 may be manufactured using a single patterning process. If the difference is larger than 1 μm, two or more patterning processes may be utilized.

Additionally, once the second die 503 has been formed, the second die 503 can be attached to the optical interconnect 100. In an embodiment the second die 503 may be attached using a similar process as the attachment of the first die 501 to the optical interconnect 100, such as by using a fusion bonding process that bonds the first bonding layer 305 to the third bonding layer 521. However, any suitable bonding process may be utilized.

FIG. 5 additionally illustrates a gap-fill material 523 that may be deposited in order to fill the space around the first die 501 and the second die 503. In an embodiment the gap-fill material 523 may be a material such as silicon oxide, silicon nitride, silicon oxynitride, combinations of these, or the like, deposited to fill and overfill the spaces between and around the first die 501 and the second die 503. However, any suitable material and method of deposition may be utilized.

Of course, while a particular process has been described above in which the gap-fill material 523 is separate from the second bonding layer 511 and the third bonding layer 521, this is intended to be illustrative and is not intended to be limiting. In other embodiments, the gap-fill material 523, the second bonding layer 511 and the third bonding layer 521 may be deposited simultaneously around the first die 501 and the second die 503 prior to the attachment and a continuous material may be formed. Any suitable materials and processes may be utilized in order to attach the first die 501 and the second die 503 to the optical interconnect 100. All such methods and materials are fully intended to be included within the scope of the embodiments.

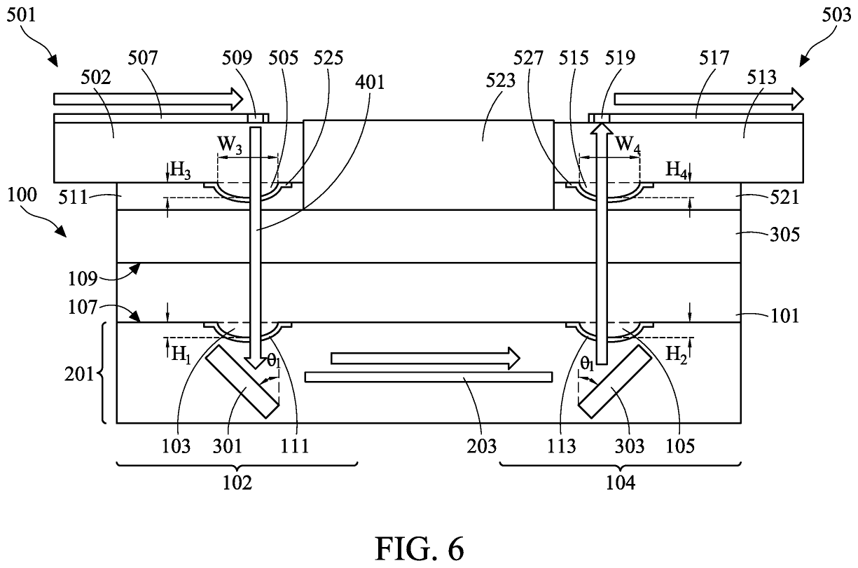

FIG. 6 illustrates a transmission of the optical signal 401 through the first die 501, to the optical interconnect 100, and back to the second die 503. In particular, the optical signal 401 passes through the first optical device signal component 507 to the third mirror 509, which reflects the optical signal 401 through the third lens 505 and the first lens 103. The optical signal 401 then is reflected by the first mirror 301, directed and/or modulated by the first optical components 203 to the second mirror 303, which reflects the optical signal 401 through the second lens 105 and fourth lens 515. Finally, the optical signal 401 is received by the fourth mirror 519 and directed through the second optical device signal component 517.

However, by tailoring the individual lens (e.g., the first lens 103, the second lens 105, the third lens 505, and the fourth lens 515) to the purpose of the lens (e.g., transmission or receiving the optical signal 401), transmission losses can be reduced. In particular, by tailoring the first lens 103 and the third lens 505 to reduce receiving losses as the optical signal 401 goes from the first die 501 to the optical interconnect 100, optical losses from that transmission can be reduced. Similarly, by separately tailoring and using different dimensions for the second lens 105 and the fourth lens 515, optical losses from transmitting the optical signal 401 to the second die 503 can be reduced. Such a tailoring allows for a overall reduction in optical losses.

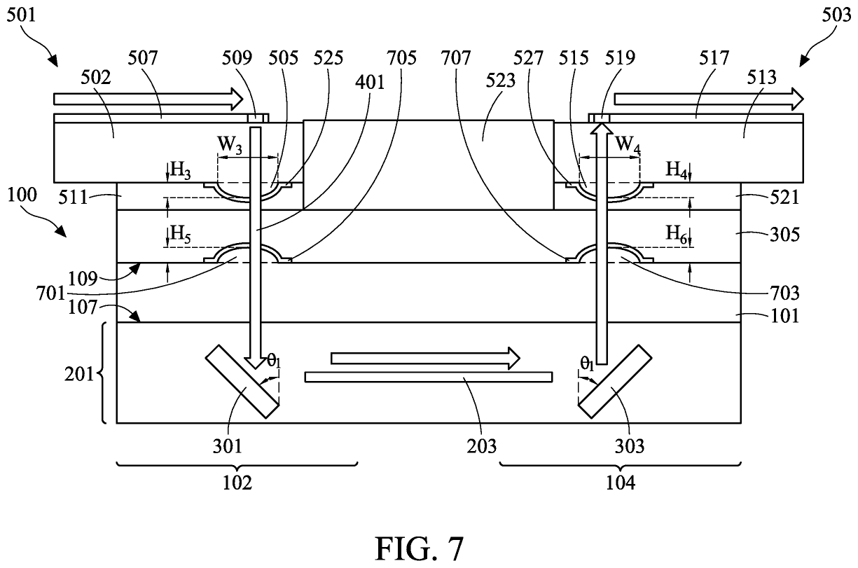

FIG. 7 illustrates another embodiment in which a fifth lens 701 and a sixth lens 703 are formed on the second side 109 of the first substrate 101 (e.g., facing away from the first active layer 201 of the first optical components 203) instead of forming the first lens 103 and the second lens 105 on the first side 107 of the first substrate 101. In this embodiment the fifth lens 701 and the sixth lens 703 may be formed using similar methods and materials as the first lens 103 and the second lens 105, such as by using one or more photolithographic masking and etching processes in order to shape the material of the first substrate 101 into the fifth lens 701 and the sixth lens 703. However, any suitable methods and materials may be utilized to form the fifth lens 701 and the sixth lens 703.

In an embodiment the fifth lens 701 is shaped in order to minimize optical losses from receiving the optical signal 401 from the first die 501. For example, in a particular embodiment the fifth lens 701 may have a fifth height H₅ of between about 2 μm and about 13 μm and a fifth width W₅ of between about 50 μm and about 120 μm. As such the fifth lens 701 may have a radius of curvature of between about 160 μm and about 800 μm. However, any suitable dimensions may be utilized.

Additionally, the sixth lens 703 is shaped to minimize optical losses from transmitting the optical signal 401 from the optical interconnect 100 to the second die 503 and has different dimensions from the fifth lens 701. For example, in a particular embodiment the sixth lens 703 may have a sixth height H₆ of between about 2 μm and about 12 μm and a sixth width W₆ of between about 50 μm and about 120 μm. As such, the sixth lens 703 has a radius of curvature that is different from the radius of curvature of the fifth lens 701, such as by having a radius of curvature of between about 155 μm and about 900 μm. However, any suitable dimensions may be utilized.

In particular examples in which the fifth lens 701 has a different dimension from the sixth lens 703, when the fifth height H₅ is the same as the sixth height H₆, then the fifth width W₅ is not equal to the sixth width W₆. In other embodiments the fifth height H₅ may be different from the sixth height H₆, the fifth width W₅ may be equal to the sixth width W₆. In yet other embodiments, the fifth height H₅ may not be equal to the sixth height H₆ while the fifth width W₅ is not equal to the sixth width W₆.

Additionally, while the formation of the fifth lens 701 may be manufactured using separate masking and etching processes from the sixth lens 703, this is intended to be illustrative and is not intended to limit the presented embodiments. Rather, is some embodiments, such as when a difference between the fifth height H₅ and the sixth height H₆ is between 0 μm and 1 μm, the fifth lens 701 and the sixth lens 703 may be manufactured using a single patterning process. If the difference is larger than 1 μm, two or more patterning processes may be utilized.

FIG. 7 additionally illustrates formation of a fifth ARC 705 and a sixth ARC 707 adjacent to the fifth lens 701 and the sixth lens 703, respectively. In an embodiment the fifth ARC 705 and the sixth ARC 707 are formed using similar materials and methods as the first ARC 111 and the second ARC 113, such as depositing one or more materials and then patterning the deposited material. However, any suitable materials and methods may be utilized.

Once the fifth lens 701 and the sixth lens 703 have been formed, the first die 501 and the second die 503 may be attached to the optical interconnect 100. In an embodiment the first die 501 and the second die 503 may be attached as described above with respect to FIG. 5. However, any suitable methods may be utilized.

Additionally, once the first die 501 and the second die 503 have attached, the optical interconnect 100 functionally connects the first die 501 to the second die 503. For example, the optical signal 401 may come from the first die 501 (e.g., through the third lens 505) and be received by the optical interconnect 100 through the fifth lens 701 and to the first active layer 201 of the first optical components 203. The first optical components 203 route the optical signal 401 through the sixth lens 703 and transmit the optical signal 401 from the optical interconnect 100 to the second die 503.

However, with each of the third lens 505, the fourth lens 515, the fifth lens 701, and the sixth lens 703 being individually and separately tailored to minimize optical losses based on how the optical signal 401 goes through the individual lens (e.g., either being transmitted or received), the losses through the optical interconnect 100 at each lens can be reduced. As such, by reducing the losses through each lens, the overall losses of transmitting the optical signal 401 through the optical interconnect 100 can be reduced. This reduction leads to a more efficient transmission of the optical signal 401.

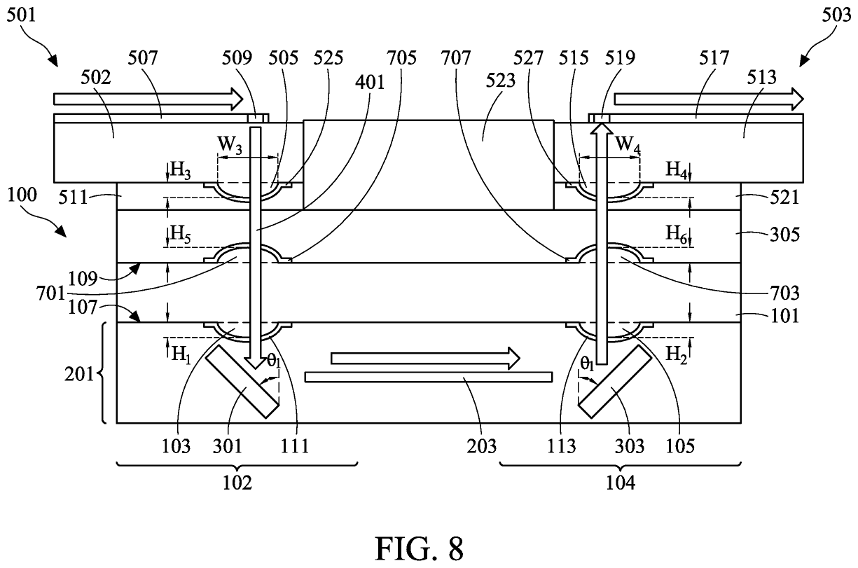

FIG. 8 illustrates yet another embodiment which utilizes the fifth lens 701 and the sixth lens 703. In this embodiment, however, instead of not forming the first lens 103 and the second lens 105 on the first side 107 of the first substrate 101, the fifth lens 701 and the sixth lens 703 are formed on the first substrate 101 along with the first lens 103 and the second lens 105. However, the first lens 103 and the second lens 105 are formed on an opposite side (e.g., the first side 107) from the fifth lens 701 and the sixth lens 703 (which are formed on the second side 109). In this embodiment the first lens 103 and the second lens 105 may be formed as described above with respect to FIG. 1, while the fifth lens 701 and the sixth lens 703 may be formed as described above with respect to FIG. 7. However, any suitable methods and materials may be utilized.

In this embodiment, each of the first lens 103, the second lens 105, the third lens 505, the fourth lens 515, the fifth lens 701, and the sixth lens 703 are individually and separately tailored to minimize optical losses based on how the optical signal 401 goes through the individual lens (e.g., either being transmitted or received). As such, losses through the optical interconnect 100 at each of the individual lens can be reduced. As such, by reducing the losses through each lens, the overall losses of transmitting the optical signal 401 through the optical interconnect 100 can be reduced. This reduction leads to a more efficient transmission of the optical signal 401.

Additionally, while the described embodiments describe the first lens 103 having different dimensions from the second lens 105 at the same time that the fifth lens 701 has different dimensions from the sixth lens 703 and at the same time that the third lens 505 has different dimensions from the fourth lens 515, this is intended to be illustrative and is not intended to be limiting. Rather, the first lens 103 may have different dimensions from the second lens 105 while the dimensions of the fifth lens 701 and the sixth lens 703 are the same, or the fifth lens 701 and the sixth lens 703 may have different dimensions while the first lens 103 and the second lens 105 have the same dimensions. Any suitable combinations may be utilized, and all such combinations are fully intended to be included within the scope of the embodiments.

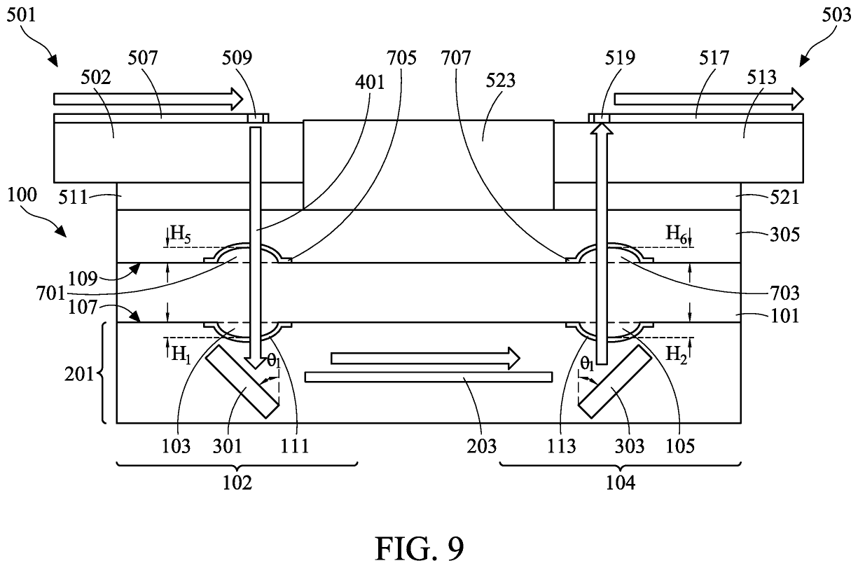

FIG. 9 illustrates yet another embodiment which utilizes the fifth lens 701 and the sixth lens 703. In this embodiment, however, instead of using the fifth lens 701 and the sixth lens 703 with each of the first lens 103, the second lens 105, the third lens 505 and the fourth lens 515, the fifth lens 701 and the sixth lens 703 are utilized with the first lens 103 and the second lens 105 but not the third lens 505 and the fourth lens 515. In this embodiment the first die 501 and the second die 503 are formed and connected to the optical interconnect 100 without forming the third lens 505 and the fourth lens 515.

As such, each of the first lens 103, the second lens 105, the fifth lens 701, and the sixth lens 703 (all on the first substrate 1o1) are individually and separately tailored to minimize optical losses based on how the optical signal 401 goes through the individual lens (e.g., either being transmitted or received). As such, losses through the optical interconnect 100 at each of the individual lens can be reduced. By reducing the losses through each lens, the overall losses of transmitting the optical signal 401 through the optical interconnect 100 can be reduced. This reduction leads to a more efficient transmission of the optical signal 401.

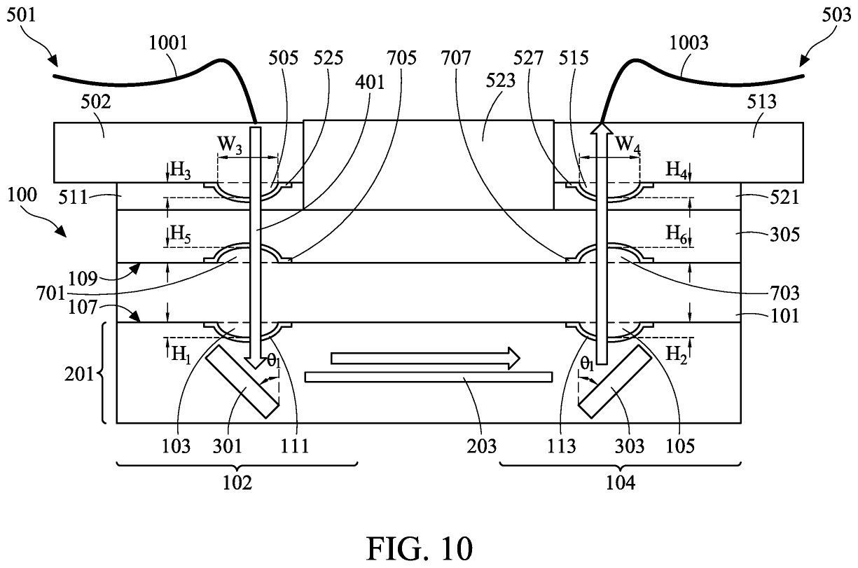

FIG. 10 illustrates yet another embodiment which uses the first lens 103, the second lens 105, the third lens 505, the fourth lens 515, the fifth lens 701, and the sixth lens 703. In this embodiment, however, the first optical device signal component 507 on the first die 501 and the second optical device signal component 517 on the second die 503 are not used. Rather, the optical signal 401 is transmitted through a first optical fiber 1001 attached to the first die 501 and a second optical fiber 1003 attached to the second die 503. In an embodiment the first optical fiber 1001 and the second optical fiber 1003 may comprise a core material surrounded by a cladding layer. Optionally, a surrounding cover material may be used to surround the cladding layer in order to provide protection. In an embodiment, the core material may comprise optical materials such as glass, air, the like, or a combination thereof. Further, the cladding layer may comprise one or more layers of cladding material, wherein the cladding material may comprise of silicon dioxide (SiO₂), silica glass, the like, or combinations thereof. However, any suitable material may be utilized for the core material and the cladding layer.

In an embodiment the first optical fiber 1001 and the second optical fiber 1003 are attached to the first die 501 and the second die 503, respectively, using an optical glue. The glue may be an epoxy material or may be more specifically an optical glue such as epoxy-acrylate and oligomers. In an embodiment, the glue may be subjected to a curing process such as a light cure, a heat cure, or the like, to harden the glue. However, any suitable material or method of attachment may be utilized.

In this embodiment the optical signal 401 travels through the first optical fiber 1001 to the first die 501 and through the third lens 505 before being transmitted to the optical interconnect 100 and through the fifth lens 701 and the first lens 103 to the first optical components 203. The first optical components 203 route and/or modulate the optical signal 401 through the second lens 105 and the sixth lens 703 before the optical signal 401 is transmitted through the fourth lens 515 to the second optical fiber 1003. However, because each of the first lens 103, the second lens 105, the third lens 505, the fourth lens 515, the fifth lens 701, and the sixth lens 703 are individually and separately tailored to minimize optical losses based on how the optical signal 401 goes through the individual lens (e.g., either being transmitted or received), losses through the optical interconnect 100 at each of the individual lens can be reduced. As such, by reducing the losses through each lens, the overall losses of transmitting the optical signal 401 through the optical interconnect 100 can be reduced. This reduction leads to a more efficient transmission of the optical signal 401.

Additionally, while the use of the first optical fiber 1001 and the second optical fiber 1003 are described above as being used with the first lens 103, the second lens 105, the third lens 505, the fourth lens 515, the fifth lens 701, and the sixth lens 703, this is intended to be illustrative and is not intended to be limiting upon the embodiments. Rather, the first optical fiber 1001 and the second optical fiber 1003 may be used with any combinations of the described lenses, such as any of the combinations described above with respect to FIGS. 1-9. Any suitable combination may be utilized, and all such combinations are fully intended to be included within the scope of the embodiments.

By utilizing the different dimensions for the different lenses as described above, the optical losses associated with transmitting and receiving the optical signal 401 to and from the optical interconnect can be reduced. In particular, the lenses associated with receiving the optical signal 401, wherein the received optical signal 401 is relatively more divergent and larger than a transmitted signal, can be sized for the more divergent signal and optical losses may be minimized. As such, overall optical losses in the system can be reduced.

In accordance with an embodiment, an optical device includes: a first substrate; a first lens on a first side of the first substrate, the first lens having a first radius of curvature; and a second lens on the first side of the first substrate, the second lens having a second radius of curvature different from the first radius of curvature. In an embodiment the optical device further includes: a third lens on a second side of the first substrate, the third lens having a third radius of curvature; and a fourth lens on the second side of the first substrate, the fourth lens having a fourth radius of curvature different from the third radius of curvature. In an embodiment the optical device further includes: a first die attached to the first substrate; and a second die attached to the first substrate. In an embodiment the optical device further includes: a third lens on the first die, the third lens having a third radius of curvature; and a fourth lens on the second die, the fourth lens having a fourth radius of curvature different from the third radius of curvature. In an embodiment the optical device further includes: a fifth lens on a second side of the first substrate, the fifth lens having a fifth radius of curvature; and a sixth lens on the second side of the first substrate, the sixth lens having a sixth radius of curvature different from the fifth radius of curvature. In an embodiment the optical device further includes first optical components adjacent to the first side of the first substrate. In an embodiment the optical device further includes first optical components adjacent to a second side of the first substrate opposite the first side of the first substrate.

In accordance with another embodiment, an optical device includes: a first substrate with an optical receiving region and an optical transmission region; a first lens within the optical receiving region; and a second lens within the optical transmission region, the second lens having a different radius of curvature from the first lens. In an embodiment the optical device further includes a first active layer of first optical components adjacent to the first lens and the second lens. In an embodiment the optical device further includes a first active layer of first optical components on an opposite side of the first substrate from the first lens and the second lens. In an embodiment the optical device further includes: a third lens within the optical receiving region on an opposite side of the first substrate than the first lens; and a fourth lens within the optical transmission region on the opposite side of the first substrate than the second lens, the fourth lens having a different radius of curvature from the third lens. In an embodiment the optical device further includes: a fifth lens aligned with the third lens and the first lens, the fifth lens on a second substrate different from the first substrate; and a sixth lens aligned with the fourth lens and the second lens, the sixth lens on a third substrate different from the first substrate and the second substrate, the sixth lens having a different radius of curvature from the fifth lens. In an embodiment the optical device further includes an optical fiber attached to the second substrate. In an embodiment the optical device further includes a fiber array unit attached to the second substrate.

In accordance with yet another embodiment, a method of manufacturing an optical device includes: forming a first lens on a first side of a first substrate; and forming a second lens on the first side of the first substrate, wherein the first lens and the second lens have different radii of curvature. In an embodiment the method further includes forming a first active layer of first optical components adjacent to the first lens and the second lens. In an embodiment the method further includes forming a first active layer of first optical components on an opposite side of the first substrate from the first lens. In an embodiment the method further includes bonding a second substrate to the first substrate, the second substrate comprising a third lens on a third side of the second substrate, the third side facing the first substrate. In an embodiment the method further includes bonding a third substrate to the first substrate, the third substrate comprising a fourth lens on a fourth side of the third substrate, the fourth side facing the first substrate, the fourth lens having a different radius of curvature from the third lens. In an embodiment the forming the first lens and the forming the second lens are formed using a single patterning process.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An optical device comprising:
a first substrate;
a first lens on a first side of the first substrate, the first lens having a first radius of curvature; and
a second lens on the first side of the first substrate, the second lens having a second radius of curvature different from the first radius of curvature.

2. The optical device of claim 1, further comprising:
a third lens on a second side of the first substrate, the third lens having a third radius of curvature; and
a fourth lens on the second side of the first substrate, the fourth lens having a fourth radius of curvature different from the third radius of curvature.

3. The optical device of claim 1, further comprising:
a first die attached to the first substrate; and
a second die attached to the first substrate.

4. The optical device of claim 3, further comprising:
a third lens on the first die, the third lens having a third radius of curvature; and
a fourth lens on the second die, the fourth lens having a fourth radius of curvature different from the third radius of curvature.

5. The optical device of claim 4, further comprising:
a fifth lens on a second side of the first substrate, the fifth lens having a fifth radius of curvature; and
a sixth lens on the second side of the first substrate, the sixth lens having a sixth radius of curvature different from the fifth radius of curvature.

6. The optical device of claim 1, further comprising first optical components adjacent to the first side of the first substrate.

7. The optical device of claim 1, further comprising first optical components adjacent to a second side of the first substrate opposite the first side of the first substrate.

8. An optical device comprising:
a first substrate with an optical receiving region and an optical transmission region;
a first lens within the optical receiving region; and
a second lens within the optical transmission region, the second lens having a different radius of curvature from the first lens.

9. The optical device of claim 8, further comprising a first active layer of first optical components adjacent to the first lens and the second lens.

10. The optical device of claim 8, further comprising a first active layer of first optical components on an opposite side of the first substrate from the first lens and the second lens.

11. The optical device of claim 8, further comprising:
a third lens within the optical receiving region on an opposite side of the first substrate than the first lens; and
a fourth lens within the optical transmission region on the opposite side of the first substrate than the second lens, the fourth lens having a different radius of curvature from the third lens.

12. The optical device of claim 11, further comprising:
a fifth lens aligned with the third lens and the first lens, the fifth lens on a second substrate different from the first substrate; and
a sixth lens aligned with the fourth lens and the second lens, the sixth lens on a third substrate different from the first substrate and the second substrate, the sixth lens having a different radius of curvature from the fifth lens.

13. The optical device of claim 8, further comprising an optical fiber attached to the second substrate.

14. The optical device of claim 8, further comprising a fiber array unit attached to the second substrate.

15. A method of manufacturing an optical device, the method comprising:
forming a first lens on a first side of a first substrate; and
forming a second lens on the first side of the first substrate, wherein the first lens and the second lens have different radii of curvature.

16. The method of claim 15, further comprising forming a first active layer of first optical components adjacent to the first lens and the second lens.

17. The method of claim 15, further comprising forming a first active layer of first optical components on an opposite side of the first substrate from the first lens.

18. The method of claim 15, further comprising bonding a second substrate to the first substrate, the second substrate comprising a third lens on a third side of the second substrate, the third side facing the first substrate.

19. The method of claim 18, further comprising bonding a third substrate to the first substrate, the third substrate comprising a fourth lens on a fourth side of the third substrate, the fourth side facing the first substrate, the fourth lens having a different radius of curvature from the third lens.

20. The method of claim 15, wherein the forming the first lens and the forming the second lens are formed using a single patterning process.
